(19) United States
(12) Patent Application Publication
(10) Pub. No.: US 2008/0084805 A1
(43) Pub. Date: Apr. 10, 2008

(54) WRITING POWER CALIBRATING METHOD AND DATA RECORDING APPARATUS USING THE SAME

(75) Inventor: Jung-Tzu Chen, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,826

(22) Filed: Oct. 5, 2006

(51) Int. Cl. G11B 7/00

(52) U.S. Cl. 369/59.11; 369/47.5; 369/116

(57) ABSTRACT

A power calibrating method includes steps of: determining a target value for a front monitor diode signal; outputting light with a power having a writing power level and an erasing power level, durations of the writing power level being identical to durations of the erasing power level; obtaining multiple values of the front monitor diode signal and an average of the multiple values of the front monitor diode signal; and adjusting the writing power level until the average of the multiple values of the FMD signal equals to the target value.

### FIELD OF THE INVENTION

This invention relates to data recording apparatuses and, more particularly, to a method for calibrating a writing power of a data recording apparatus.

### DESCRIPTION OF RELATED ART

In recent years, data storage media that are capable of being written data thereon, such as rewritable digital versatile discs (DVD-RW) or rewritable compact discs (CD-RW) have become more and more popular. Accordingly, related data recording apparatus are developed to record data onto the data storage medium. A typical data recording apparatus employs an optical pick-up unit (OPU) to emit a laser beam onto a data storage medium to form a spot on the data storage medium. When a laser beam power reaches a first predetermined level, a position where the spot is formed is changed from a first state to a second state, a recording mark is thus formed on the data storage medium. That is, data are recorded on the data storage medium. When the laser beam power reaches a second predetermined level, the position in the second state is restored to the first state and the recording mark is cleared from the data storage medium. That is, the data recorded on the data storage medium is erased.

Before recording data onto the medium, the laser beam power should be calibrated in order to ensure accuracy of the recording. In general, the laser beam power includes three power levels: a writing power level for writing data onto the data storage medium, an erasing power level for erasing data from the data storage medium, and a biasing power level for reading data from the data storage medium. Each of the erasing power level and the biasing power level can be automatically calibrated via a separate automatic power control (APC) loop of the data recording apparatus. Each APC loop uses a sample/hold circuit connected to a front monitor diode (FMD) of the OPU to sample an output voltage of the FMD. The FMD is used for sensing the laser beam power and outputting a FMD signal to the APC loop to indicate the power of the laser beam. The APC loop adjusts the laser beam power based on the FMD signal. However, there is no APC loop specifically for adjusting the writing power level. The writing power level is adjusted by many calculations based on the FMD signal, the erasing power level, and a ratio between the writing power level and the erasing power level. Such calculations are time-consuming and accuracy of the adjustment is difficult to control.

Therefore, a writing power calibrating method is desired.

### SUMMARY OF THE INVENTION

A power calibrating method includes steps of: determining a target value for a front monitor diode signal; outputting light having a writing power level and an erasing power level, durations of the writing power level being identical to durations of the erasing power level; obtaining multiple values of the front monitor diode signal and an average of the multiple values of the front monitor diode signal; and adjusting the writing power level until the average of the multiple values of the FMD signal equals to the target value.

A data recording apparatus includes a laser diode, a laser diode driver, and a digital signal processor. The laser diode driver is used for driving the laser diode to emit a laser beam. The digital signal processor is used for controlling a duration of the laser beam. The digital signal processor controls the laser diode driver to drive the laser diode to emit the laser beam with a power in a predetermined wave form. The power in the predetermined wave form has alternate writing power levels and erasing power levels. A duration of each writing power level equals to a length of a corresponding pit included in eight-to-fourteen modulate data to be recorded.

A controlling processor for controlling a laser diode driver to drive a laser diode to emit a laser beam with a power in a predetermined wave form during a power calibrating procedure, the power in the predetermined wave form wave form comprising a first power level for forming recording marks on a medium and a second power level for erasing recording marks from the medium, a duration of the first power level being equal to a length of a corresponding pit in eight-to-fourteen modulate data to be recorded on the medium.

Other advantages and novel features will become more apparent from the following detailed description of preferred embodiments when taken in conjunction with the accompanying drawings, in which:

### BRIEF DESCRIPTION OF THE DRAWINGS

Many aspects of the writing power calibrating method and the data recording apparatus using the writing power calibrating method can be better understood with reference to the following drawings. The components in the drawings are not necessarily to scale, the emphasis instead being placed upon clearly illustrating the principles of the present writing power calibrating method and the present data recording apparatus. Moreover, in the drawings, like reference numerals designate corresponding parts throughout the several views.

FIG. 1 is a block diagram of a data recording apparatus in accordance with a first exemplary embodiment, the data recording apparatus including a laser diode (LD) and a front monitor diode (FMD);

FIG. 2 is an exemplary general wave form of a laser beam power outputted by LD of FIG. 1, the laser beam power in the general wave form including three power levels: a writing power level Pw, an erasing power level Pe, and a biasing power level Pb;

FIG. 3 is an exemplary characteristic curve illustrating relationship between the laser beam power outputted by the LD of FIG. 1 and an output voltage of the FMD of FIG. 1;

FIG. 4 are exemplary wave forms of the laser beam power outputted by the LD of FIG. 1 and the output voltage of the FMD of FIG. 1;

FIG. 5 is an exemplary circuit diagram of an APC loop in the data recording apparatus of FIG. 1;

FIG. 6 is an exemplary diagram illustrating structures of the three power levels in FIG. 2;

FIG. 7 is an exemplary curve illustrating relationships between an average of the output voltage of the FMD and a ratio of the erasing power level Pe to the writing power level Pw;

FIG. 8 are exemplary wave forms outputted by different LDs;

FIG. 9 is an exemplary diagram illustrating a contrast between the general wave form in FIG. 2 and a specific wave form in accordance with an exemplary embodiment;

FIG. 10 is a flow chart illustrating a calibrating procedure for calibrating the writing power level of a power calibrating method in accordance with an exemplary embodiment; and

FIG. 11 is a block diagram of a data recording apparatus in accordance with a second exemplary embodiment.

### DETAILED DESCRIPTION OF THE INVENTION

Reference will now be made to the drawings to describe the preferred embodiments of the present writing power control apparatus and the present writing power control method, in detail.

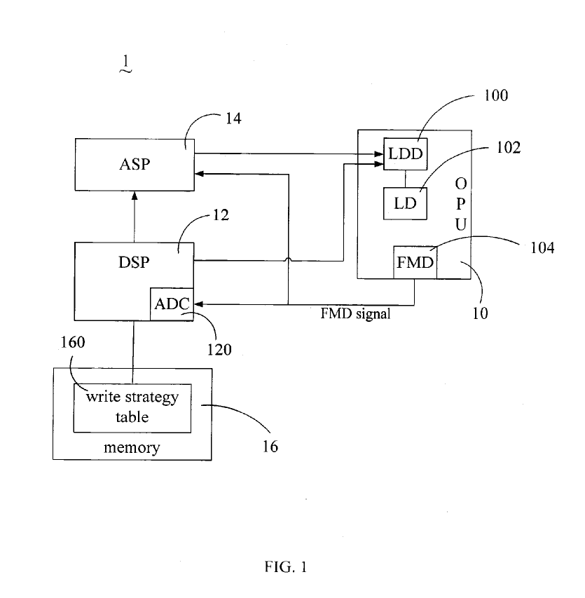

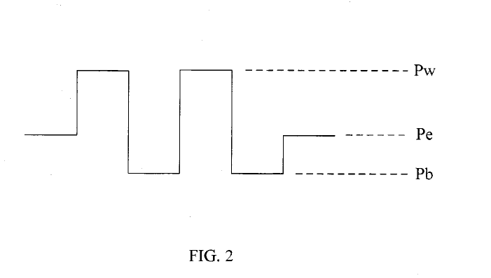

Referring to FIG. 1, a data recording apparatus 1 includes an optical pick-up unit (OPU) 10, a digital signal processor (DSP) 12, and an analog signal processor (ASP) 14. The OPU 10 includes a laser diode driver (LDD) 100 connected to the ASP 14, a laser diode (LD) 102, and a front monitor diode (FMD) 104. The LDD 100 is used for driving the LD 102 to emit a laser beam onto a data storage medium (not shown) to record data onto the data storage medium and/or reproduce data from the data storage medium. Referring also to FIG. 2, an exemplary wave form of a laser beam power outputted by the LD 102 is illustrated. The laser beam power includes three power levels: a writing power level Pw, an erasing power level Pe, and a biasing power level Pb. When the laser beam is emitted at the writing power level Pw, data is recorded on the data storage medium. When the laser beam is emitted at the erasing power level Pe, data recorded on the data storage medium is erased. When the laser beam is emitted at the biasing power level Pb, data recorded on the data storage medium is read.

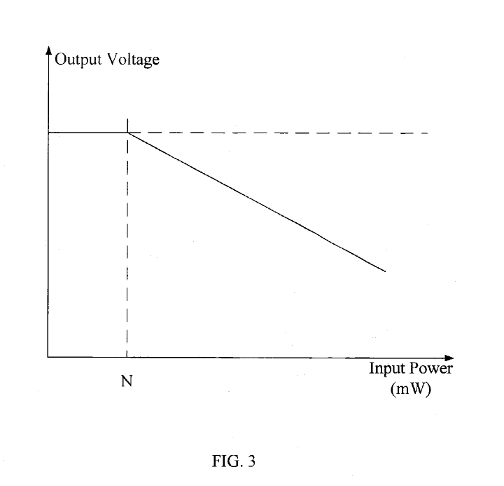

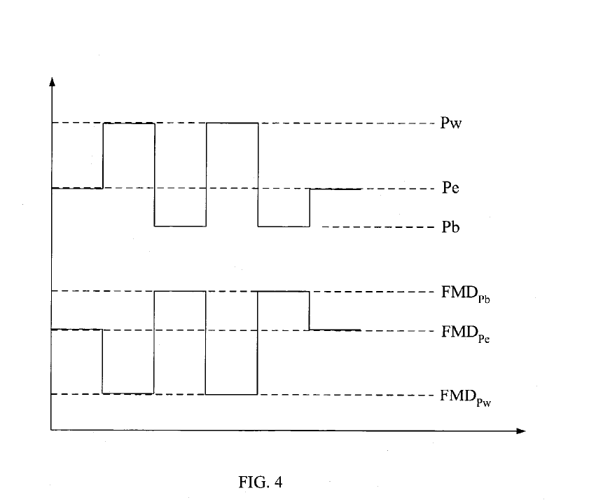

The FMD 104 is used for detecting the laser beam power and for outputting an FMD signal indicating the laser beam power to the DSP 12 and the ASP 14. Referring also to FIG. 3, an exemplary characteristic curve illustrating relationship between an input power and an output voltage of the FMD 104. The laser beam power outputted by the LD 102 serves as the input power of the FMD 104, and the output voltage of the FMD 104 is the FMD signal. If the laser beam power is lower than a given value N, the FMD 104 outputs a constant voltage. If the laser beam power exceeds the given value N, the greater the laser beam power is, the lesser the output voltage of the FMD 104. The output voltage of the FMD 104 has three voltage levels: FMD_{Pb}, FMD_{Pe}, and FMD_{Pw} respectively corresponds to the writing power level Pw, the erasing power level Pe, and the biasing power level Pb (referring to FIG. 4).

The DSP 12 is used for controlling a duration of each power level of the laser beam power and for controlling operations of the ASP 14, and includes an analog-to-digital converter (ADC) 120 connected to the FMD 104 for sampling the FMD signals. The ASP 14 is used for adjusting the laser beam power based on the FMD signal. The OPU 10, the DSP 12, and the ASP 14 collectively form an automatic power control (APC) loop. In the APC loop, the DSP 12 controls the ASP 14 to output driving signals to the LDD 100 to drive the LD 102 to emit a laser beam at a predetermined power level. The FMD 104 detects the laser beam power and outputs the FMD signal to the ASP 14, the ASP 14 then adjusts the laser beam power based on the FMD signal.

The data recording apparatus 1 further includes a memory 16 such as a read only flash memory for storing a write strategy table 160. The write strategy table 160 stores values of the erasing power level and a ratio ε of the erasing power level Pe to the writing power level Pw. Because different data storage media have different properties, when the laser beam is applied on different data storage media, the laser beam power should be calibrated to be consistent with the different properties of the data storage media. In order to provide an appropriate power for recording information on the different data storage medium, some data recording apparatuses predefine the write strategy table 160 in the memory 16. When the data recording apparatus 1 starts recording, the OPU 10 reads specific information from the data storage medium, such specific information are usually recorded in a lead-in area of the data storage medium. Based on the specific information read from the data storage medium, corresponding values of the erasing power level Pe and the ratio ε can be obtained by searching in the write strategy table 160.

The DSP 12 controls the duration of each power level of the laser beam power based on the information stored in the write strategy table 160.

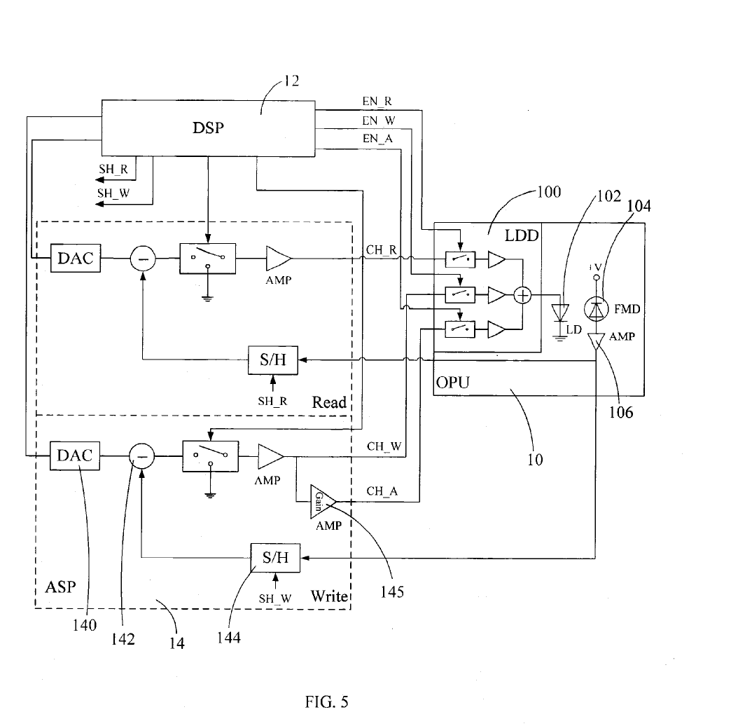

Referring to FIG. 5, an exemplary circuit diagram of the APC loop is illustrated. The ASP 14 includes two parts, one for reading information from the data storage medium, the other one for writing information onto the data storage medium. Each part includes a digital-to-analog converter (DAC) 140 that is connected to the DSP 12, a subtracter 142, and a sample/hold (S/H) unit 144 that is connected to the FMD 104 via an amplifier 106. The DAC 140 is used for receiving commands from the DSP 12 and for outputting a specified voltage based on the commands received from the DSP 12. The FMD signal outputted by the FMD 104 is first amplified by the amplifier (AMP) 106, and then the AMP 106 transmits the FMD signal amplified to the S/H unit 144. The S/H unit 144 samples the amplified FMD signal and holds the samples for a predetermined time period to provide enough time for the subtracter 142 to perform a subtraction operation. The DSP 12 controls operation and non-operation of the S/H unit 144. The subtracter 142 subtracts the amplified FMD signal from the output of the DAC 140 to obtain error signals. The error signals are then amplified by corresponding amplifiers (not labeled) to be driving signals to be fed to the LDD 100 to control the laser beam power.

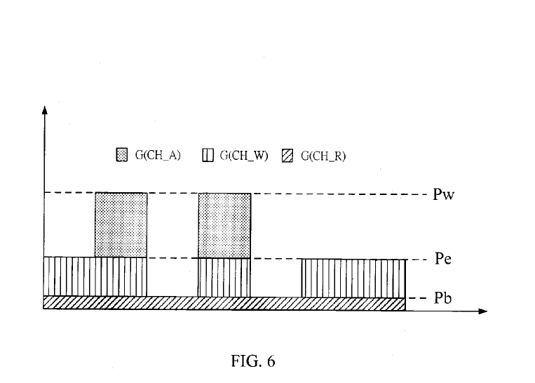

The driving signals generated in the ASP 14 include a first driving signal CH_R, a second driving signal CH_W, and a third driving signal CH_A. The first driving signal CH_R is used for adjusting the magnitude of the biasing power level Pb, the second driving signal CH_W is used for adjusting the magnitude of the erasing power level Pe, and the third driving signal CH_A is used for adjusting the magnitude of the writing power level Pw. The second driving signal CH_W is multiplied by a gain 145 to get the third driving signal CH_A. Each of the three driving signals CH_A, CH_W, and CH_R is transmitted to the LDD 100 via a separate channel, and then amplified by corresponding amplifiers (not labeled) in the corresponding channel before fed to an adder (not labeled). The three driving signals amplified are identified as G1(CH_A), G2(CH_W), and G3(CH_R), respectively. Each of G1, G2, and G3 represents a gain function of a corresponding channel. The adder adds up the three driving signals amplified G1(CH_A), G2(CH_W), and G3(CH_R) before the three driving signals amplified are fed to the LD 102. Referring to FIG. 6, the writing power level Pw equals to a sum of the three driving signals amplified (that is Pw=Σ(G1(CH_A), G2(CH_W), G3(CH_R))), the erasing power level Pe equals to a sum of G3(CH_W) and G2(CH_R) (that is Pe=Σ(G2(CH_W), G3(CH_R))), and the biasing power level Pb equals to G3(CH_R).

Because each of the first driving signal CH_R and the second driving signal CH_W can be adjusted by a corresponding APC loop, the CH_A is obtained by multiplying CH_A by the gain 145, and the writing power level Pw equals to Σ(G(CH_A), G(CH_W), G(CH_R)), the writing power level Pw can be calibrated by adjusting the value of the gain 145.

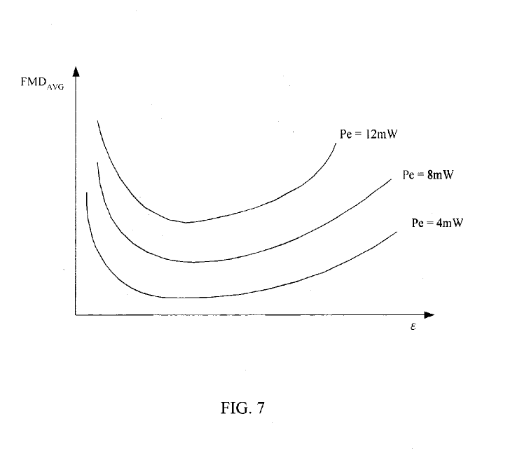

An exemplary general procedure for adjusting the value of the gain 145 is as follows. First, the DSP 12 controls the LDD 100 to drive the LD 102 to output a laser beam with a power in a predetermined wave form. Second, the ADC 120 of the DSP 12 samples the output voltage of the FMD 104 to obtain more than one thousand sampled values of the FMD signal. An average FMD_{AVG} of the values of the FMD signal is obtained by averaging the sampled values. Third, a relationship among the FMD_{AVG}, the erasing power level Pe, and the ratio ε is established and stored in the data recording apparatus 1. An exemplary relationship among the FMD_{AVG}, the erasing power level Pe, and the ratio ε is illustrated in FIG. 7. Fourth, a corresponding value of the FMD_{AVG} corresponding to given values of the erasing power level Pe and the ratio ε is obtained according to the relationship among the FMD_{AVG}, the erasing power level Pe, and the ratio ε. The corresponding valued of the FMD_{AVG} is used as a target value FMD_{TGT} of the FMD signal. Sixth, the DSP 12 controls the LDD 100 to drive the LD 102 to output the laser beam with the power in the predetermined wave form and the ADC 120 samples the output voltage of the FMD 104 more than one thousands times to obtain a new average FMD_{AVG}. If the newly obtained FMD_{AVG} equals to the FMD_{TGT}, the adjustment of the value of the gain 145 is finished. Otherwise, the procedure loops back to the sixth step to adjust the value of the gain 145.

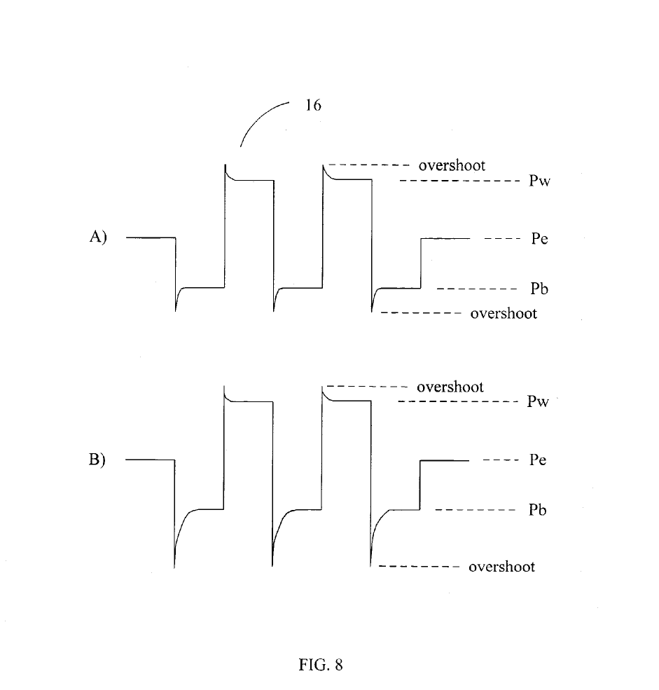

However, different LDs 102 may output laser beams with powers in different wave forms even if being given same commands by the DSP 12 due to their different inherent characteristics. The wave form shown in FIG. 2 is an ideal wave. In fact, a real wave form of the laser beam power outputted by the LD 102 is not as ideal as the wave form shown in FIG. 2. At an ascending edge or a descending edge of the real wave form, an overshoot may be generated due to inherent properties of the LD 102. Because different LDs 102 have different inherent properties, different overshoots may be generated (Referring to FIG. 8). The wave forms A) and B) corresponds to two different LDs. It is clear that the overshoot in wave form A) is smaller than the overshoot in the wave form B). Because the FMD signal is dependent on the laser beam power outputted by the LD 102, the FMD signal may be biased due to the overshoots. Therefore, the value of the FMD_{AVG} is badly influenced. When different LDs 102 are applied in the data recording apparatus 1, the relationships among the FMD_{AVG}, the erasing power level Pe, and the ratio ε may be modified according to the different LDs 102. It may be a troublesome task to modify the relationship among the FMD_{AVG}, the erasing power level Pe, and the ratio ε. If the overshoots cause the value of FMD_{AVG} to bias away from an ideal value too much, an accuracy of calibration of the writing power level Pw is degraded.

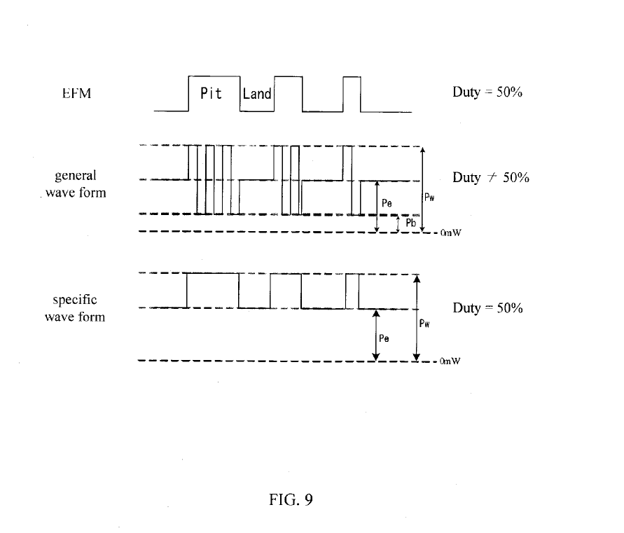

In order to reduce the deviation of the FMD_{AVG} caused by the different inherent properties of the different LDs 102, a specific wave form is proposed. The specific wave form has less ascending/descending edges than the wave form shown in FIG. 2 (hereinafter referred as to general wave form). Referring to FIG. 9, a contrast between the specific wave form and the general wave form is illustrated. In general, the information to be recorded onto the data storage medium is firstly converted to eight-to-fourteen modulate (EFM) data. The EFM data employs a shift between a “pit” and a “land” to represent a bit “1”. Each “pit” represents a recording mark recorded on the data storage medium. Corresponding to each “pit”, there is more than one pulse in the general wave form, whilst only one pulse in the specific wave form. It can be seen that each pulse has the ascending edge and the descending edge. Since the number of the pulses in the specific wave form is less than the number of the pulses in the general wave form, the number of the ascending edges and the descending edges is reduced. Accordingly, the number of the overshoots is also decreased and the deviation placed on the FMD_{AVG} by the overshoots is reduced.

Since the power in the specific wave form has only two power levels: the writing power level Pw and the erasing power level Pe, the FMD only has only values that include FMD_{Pw} and FMD_{Pe}, according to the relationship between the laser beam power and the FMD signal shown in FIG. 3. In general, with respect to the EFM wave form, a duty ratio of the “pits” is 50%. That is, the number of the “pits” is identical to the number of the “lands”. Because there is only one pulse in the specific wave form corresponding to each “pit”, a total duration of the writing power level Pw equals to that of the erasing power level Pe. That is, a duty ratio of the writing power level Pw is 50%. Accordingly, a total duration of the FMD_{Pw} is also identical to that of the FMD_{Pe}. The FMD_{AVG} can be obtained by averaging the FMD_{Pw} and the FMD_{Pe}.

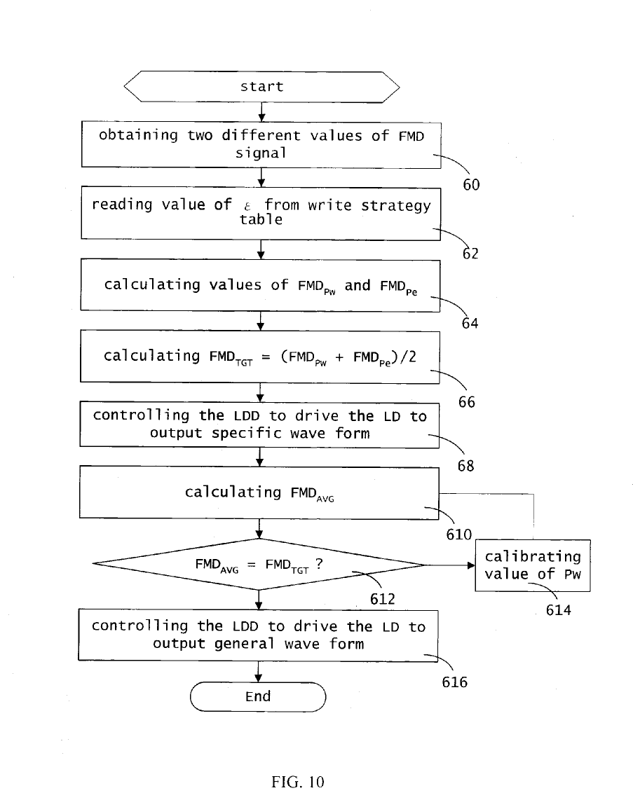

Referring to FIG. 10, a calibrating procedure for calibrating the writing power level Pw of a power calibrating method in accordance with an exemplary embodiment is illustrated. The calibrating procedure includes following steps.

First, in step 60, two different values of the FMD signal are obtained. The DSP 12 controls the LDD 100 to drive the LD 102 to output the laser beam with two different static direct current (DC) powers PW_DC1 and PW_DC2. Then, the ADC 120 samples the output voltage of the FMD 104 under each DC power to get two different values FMD_{DC1} and FMD_{DC2} of the FMD signal.

Second, in step 62, corresponding values of the ratio ε and the erasing power level Pe are read from the write strategy table 160. Based on the values of the ratio ε and the erasing power level Pe, the value of the writing power level Pw is obtained.

Third, in step 64, values of the FMD_{Pe} and FMD_{Pw} are obtained by interpolation, based on the two different values of the FMD signal.

Fourth, in step 66, the value of the FMD_{TGT} is calculated by averaging the value of the FMD_{Pe} and FMD_{Pw}.

Fifth, in step 68, the DSP 12 controls the ASP 14 to drive the LD 102 to output the specific wave form.

Sixth, in step 610, the ADC 120 samples the output voltage of the FMD 104 for more than one thousand times to get more than one thousand values of the FMD signal. Then, the value of the FMD_{AVG} is obtained by averaging the more than one thousand values of the FMD signal.

Seventh, in step 612, a conclusion is made as to whether the value of the FMD_{AVG} equals to that of the FMD_{TGT}.

Eighth, if the value of the FMD_{AVG} is concluded to not be equal to that of the FMD_{TGT} in step 612, the value of the writing power level Pw is calibrated by adjusting the value of the gain (step 614).

Ninth, if the value of the FMD_{AVG} is concluded to be equal to that of the FMD_{TGT} in step 612, the calibration of the writing power level Pw is accomplished and the DSP 12 controls the ASP 14 to drive the LD 102 to output the general wave form to perform recording operations (step 616).

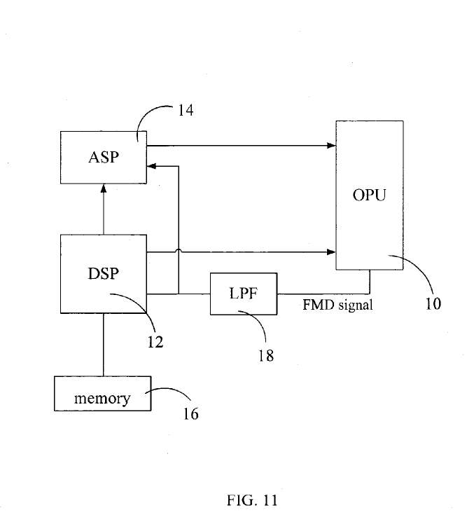

It should be noted that in order to reduce the number of the overshoots, a writing rate of the data recording apparatus 1 is preferably low, such as a double of a base recording rate (know as 2×). The base recording rate is specified for each type of data storage medium. For example, a base recording rate of a compact disc audio (CD_DA) disc is specified to be 150 Kbps. Furthermore, a low pass filter 18 can be added between the ADC 120 and the FMD 104 in order to further lower the deviation on the value of the FMD signal caused by the overshoots (referring to FIG. 11).

The embodiments described herein are merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims that follow, and their equivalents.

What is claimed is:

1. A power calibrating method, comprising steps of:
determining a target value for a front monitor diode signal;
outputting light with a power having a writing power level and an erasing power level, durations of the writing power level being identical to durations of the erasing power level;
obtaining multiple values of the front monitor diode signal and an average of the multiple values of the front monitor diode signal; and
adjusting the writing power level until the average of the multiple values of the FMD signal equals to the target value.

2. The power calibrating method as claimed in claim 1, wherein the step of determining the target value comprises steps of:
calculating a first value of the front monitor diode signal corresponding to a given erasing power level;
calculating a second value of the front monitor diode signal corresponding to a given writing power level; and
determining the target value by averaging the first value and the second value.

3. The power calibrating method as claimed in claim 2, wherein the step of determining the target value by averaging the first value and the second value comprises a step of sampling two different values of the front monitor diode signal corresponding to two different direct current, and the first value and the second value are calculated by interpolation based on the sampled two different values of the front monitor diode signal.

4. The power calibrating method as claimed in claim 2, wherein the given erasing power level is obtained from a write strategy table, the write strategy table further predefines a ratio between the writing power level and the erasing power level, and the given writing power level is obtained based on the given erasing power level and the ratio.

5. The power calibrating method as claimed in claim 1, wherein a duration of each writing power level equals to a length of a pit in an eight-to-fourteen modulate data to be recorded.

6. The power calibrating method as claimed in claim 1, wherein a writing rate of the light is double of a base recording rate.

7. A data recording apparatus, comprising:
a laser diode for emitting laser beam;
a laser diode driver for driving the laser diode to emit the laser beam;
a digital signal processor for controlling a duration of the laser beam, and instructing the laser diode driver to drive the laser diode to emit the laser beam with a power in a predetermined wave form, the power in the predetermined wave form having alternate writing power levels and erasing power levels, a duration of each writing power level being equal to a length of a corresponding pit included in eight-to-fourteen modulate data to be recorded.

8. The data recording apparatus as claimed in claim 7, wherein a sum of durations of the writing power levels equals to a sum of durations of the erasing power levels.

9. The data recording apparatus as claimed in claim 7, wherein a writing rate of the laser beam in the predetermined wave form is double of a base recording rate.

10. The data recording apparatus as claimed in claim 7, wherein the predetermined wave form is used for calibrating the power of the laser beam.

11. The data recording apparatus as claimed in claim 7, further comprising a front monitor diode for detecting the laser beam power and outputting a front monitor diode signal to the digital signal processor.

12. The data recording apparatus as claimed in claim 11, further comprising an analog signal processor for controlling the power of the laser beam.

13. The data recording apparatus as claimed in claim 12, wherein the erasing power level is calibrated by the analog signal processor based on the front monitor diode signal.

14. The data recording apparatus as claimed in claim 12, wherein the writing power level is calibrated by having an average of multiple values of the front monitor diode signal that is sampled under the laser beam in the predetermined wave form equal to a given target value.

15. The data recording apparatus as claimed in claim 14, wherein the given target value is obtained by averaging a first value of the front monitor diode signal and a second front monitor diode signal, the first value corresponding to a predetermined erasing power level, the second value corresponding to a predetermined writing power level.

16. The data recording apparatus as claimed in claim 7, further comprising a write strategy table for recording at least one value for the erasing power level and at least value for a ratio of the erasing power level to the writing power level, the predetermined erasing power level is read from the write strategy table, and the predetermined writing power level is determined based on the predetermined erasing power level and a corresponding value of a ratio of the writing power level to the erasing power level, the corresponding value of the ratio being read from the write strategy table.

17. A controlling processor for instructing a laser diode driver to drive a laser diode to emit a laser beam with a power in a predetermined wave form during a power calibrating procedure, the power in a predetermined wave form comprising a first power level for forming recording marks on a medium and a second power level for erasing the recording marks from the medium, a duration of the first power level being equal to a length of a corresponding pit in eight-to-fourteen modulate data to be recorded on the medium.

18. The controlling processor as claimed in claim 17, wherein a writing rate of the laser beam during the power calibrating procedure is double of a base recording rate.

19. The controlling processor as claimed in claim 17, wherein a sum of durations of the first power levels equals to a sum of durations of the second power levels.
